(19) United States
(12) Patent Application Publication
(10) Pub. No.: US 2025/0261796 A1
(43) Pub. Date: Aug. 21, 2025

(54) ELECTRIC GRINDER

(71) Applicant: Songzi Wang, Shenzhen (CN)

(72) Inventor: Songzi Wang, Shenzhen (CN)

(21) Appl. No.: 18/619,390

(22) Filed: Mar. 28, 2024

(30) Foreign Application Priority Data
Feb. 20, 2024 (CN) 202410192296.5

(51) Int. Cl. A47J 42/26; A47J 42/30

(52) U.S. Cl. CPC A47J 42/26; A47J 42/30

(57) ABSTRACT

An electric grinder includes an upper shell, a lower shell, a driving assembly, a rotating assembly, an upper grinding piece, and a lower grinding piece. The lower shell is detachably connected to the upper shell, the driving assembly is installed on the upper shell, the rotating assembly is installed on the driving assembly, the upper grinding piece is installed on the rotating assembly, and a grinding part is provided on the upper grinding piece. The lower grinding piece can be detachably connected to the second chamber, and there are multiple through holes on the lower grinding piece. Due to the fact that the driving assembly can drive the grinding part to move, the material in the grinding space can be compacted, so that the grinding part and the material can always maintain a relatively large frictional force during the relative movement process, thus fully grinding the material.

### FIELD OF THE INVENTION

The present invention relates to the field of grinder technology, especially to an electric grinder.

### BACKGROUND OF THE INVENTION

Grinding is a method for processing materials, such as ingredients and medicinal herbs, processing them into small powder like particles can release the flavor of the ingredients or the efficacy of the medicinal herbs as much as possible. With the development of society and technology, the grinding of materials has now been completed by mechanized equipment.

Current electric grinders often encounter some problems during use, for example, in order to ensure that grinding components such as grinding teeth, grinding blade, and others can grind to the material, the grinding components usually run through the entire grinding space, which leads to a portion of the grinding space being occupied by the grinding components, resulting in a reduction in the amount of material that can be accommodated in the grinding space. In addition, grinding is achieved through the frictional force generated by the relative motion between the grinding components and the material. During the grinding process, the material will transform from a coarse structure to powder like small particles, while the volume of the grinding space remains unchanged, the material will transition from a denser state to a looser state, for example, larger particles can fill the cup, but smaller particles loaded in the cup can only occupy a part of the cup, especially for some electric grinders that can discharge the grinded material while grinding, due to the reduced amount of material in the grinding space, it will become more loose, which leads to a lower friction force generated when the material comes into contact with the grinding part as the grinding process progresses, resulting in a poorer grinding effect and inability to fully grind the material.

### SUMMARY OF THE INVENTION

### (1) Solved Technical Problem

To solve the above problems, the present invention provides an electric grinder that can accommodate more materials and keep the materials in a dense state during the grinding process, thereby grinding the materials more fully.

### (2) Technical Solution

To achieve the above objectives, the present invention provides the following technical solution:

An electric grinder for grinding materials includes: an upper shell equipped with a first chamber having an opening at one end thereof; a lower shell equipped with a second chamber having an opening at one end thereof, and the lower shell detachably connected to the upper shell to form a closed chamber enclosed by the first chamber and the second chamber; a driving assembly installed on the upper shell and extending into the first chamber, and being movable along the first chamber; a rotating assembly installed on the driving assembly, and a rotating plane of the rotating assembly intersects with a movement direction of the driving assembly; a lower grinding piece detachably connected to the second chamber and enclosed with the lower shell, the upper grinding piece, and the upper shell to form a grinding space for grinding materials; the lower grinding piece being equipped with multiple through holes for discharging the material after grinding in the grinding space. Wherein the driving assembly drives the rotating assembly to move, and the rotating assembly drives the upper grinding piece to rotate, so that the grinding part can move, squeeze, and rotate the material in the grinding space.

### (3) Beneficial Effects

Compared with the prior art, the present invention brings the following beneficial effects:

Place the material that needs to be grinded into the grinding space enclosed by the lower grinding piece, lower shell, upper grinding piece, and upper shell, then connect and fix the lower shell and upper shell. After the chamber is closed, drive the rotating assembly and upper grinding piece to move by the driving assembly, so that the grinding part presses the material onto the lower grinding piece. Then, drive the grinding part to rotate through the rotating assembly to grind the material. After grinding, the powdered material will fall down through the gap between the coarse materials, and will be discharged into the space between the lower grinding piece and the lower shell through a through hole, allowing the grinding part to always come into contact with the coarse material, i.e., larger volume of material.

Due to the fact that the driving assembly can drive the grinding part to move, even if the coarse material continuously turns into a powder like material and the powder like material is continuously discharged from the grinding space through the through hole, the grinding part can still move by the driving assembly, reducing the grinding space and compacting the material in the grinding space, so that the grinding part and the material can always maintain a large friction force during relative motion, thus fully grinding the material. Overall, by using this electric grinder, more material can be accommodated and kept in a dense state throughout the grinding process, thus grinding the material more thoroughly.

### BRIEF DESCRIPTION OF THE DRAWINGS

FIG. 1 is a schematic structural view of an electric grinder according to an embodiment of present invention.

FIG. 2 is another schematic structural view of the electric grinder according to an embodiment of present invention.

FIG. 3 shows the electric grinder of FIG. 1 in an open state.

FIG. 4 shows an internal structure inside the upper shell of the electric grinder of FIG. 1 by the upper shell.

FIG. 5 is an exploded view of part of the internal structure of FIG. 4.

FIG. 6 is an assembled schematic structural view of the first shell, lower grinding piece and the connecting piece of the electric grinder of FIG. 1.

FIG. 7 is an exploded view of the first shell, lower grinding piece and the connecting piece of FIG. 6.

FIG. 8 shows the enlarged view of part A of FIG. 7.

FIG. 9 shows the enlarged view of part B of FIG. 7.

FIG. 10 shows three types of lower grinding pieces according to an embodiment of present invention.

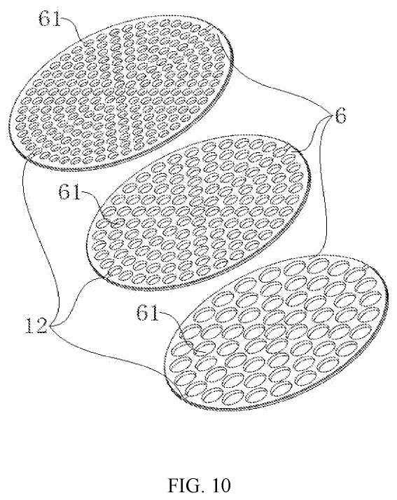

FIG. 11 shows the second shell and the filtering assembly of the electric grinder of FIG. 1 according to an embodiment of present invention.

FIG. 12 is an exploded view of the second shell and the filtering assembly of FIG. 11.

Labels in the drawing: 1, upper shell; 2, lower shell; 201, first shell; 202, second shell; 3, driving assembly; 31, moving member; 32, guiding member; 4, rotating assembly; 41, main body; 42, driving shaft; 5, upper grinding piece; 51, grinding part; 511, grinding surface; 6, lower grinding piece; 61, through hole; 7, power supply; 8, first conductive element; 9, second conductive element; 10, alarm; 11, first liming part; 12, second limiting part; 13, connecting piece; 14, filtering assembly; 141, frame; 142 filter screen; 15, guiding hole; 16, fixing member; 161, hole; 17, elastic member; 18, first magnetic member; 19, second magnetic member; 191, positioning hole; 20, buckle structure; 21, rotatable buckle structure; 211, groove; 212, block; 213, insertion slot; 214, insertion protrusion; 22, storage battery; 23, switch; 24, control panel; 25, charging socket

### DETAILED DESCRIPTION OF PREFERRED EMBODIMENTS

The following will provide a clear and complete description of the technical solution in the embodiments of the present invention, in conjunction with the accompanying drawings. Obviously, the described embodiments are only a part of the embodiments of the present invention, not all of them. Based on the embodiments in the present invention, all other embodiments obtained by ordinary technicians in the art without creative labor fall within the scope of protection of the present invention.

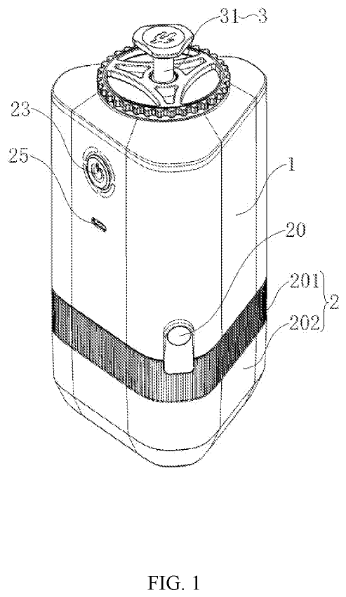

Referring to FIGS. 1 and 3-4, an electric grinder according to an embodiment of present invention is provided for grinding materials. The electric grinder includes an upper shell 1, a lower shell 2, a driving assembly 3, a rotating assembly 4, an upper grinding piece 5, and a lower grinding piece 6.

The upper shell 1 is equipped with a first chamber with an opening at one end, and the lower shell 2 is equipped with a second chamber with an opening at one end. The lower shell 2 can be detachably connected to the upper shell 1 to form a closed chamber enclosed by the first chamber and the second chamber.

The driving assembly 3 is installed on the upper shell 1 and corresponds to the first chamber, which can move along the first chamber. The rotating assembly 4 is installed on the driving assembly 3, and when the rotating assembly 4 rotates, a plane where the rotating assembly 4 rotates intersects with the movement direction of the driving assembly 3.

The upper grinding piece 5 is installed at one end of the rotating assembly 4 near the lower shell 2. The upper grinding piece 5 protrudes and can enter the second chamber of the lower shell 2 under the action of the driving assembly 3.

The upper grinding piece 5 has a grinding part 51 at an end thereof, which is a disc-shaped structure and has a grinding surface 511 that is tangent or nearly tangent to the upper grinding piece 5 or the upper shell 1, which can increase the contact area and friction force between the grinding part 51 and the material during grinding.

The lower grinding piece 6 can be detachably connected to the second chamber and forms a grinding space enclosed by the lower shell 2, the upper grinding piece 5, and the upper shell 1 for materials to be placed. There are multiple through holes 61 formed on the lower grinding piece 6, which are used to discharge the materials after grinding in the grinding space.

When in use, the driving assembly 3 drives the rotating assembly 4 to move, and the rotating assembly 4 drives the upper grinding piece 5 to rotate, so that the grinding part 51 moves, squeezes, and rotates the materials in the grinding space, so that the materials are always in a compact or dense state during the grinding process.

In particular, in actual use, first, the material to be grinded is placed into the grinding space enclosed by the lower grinding piece 6, lower shell 2, upper grinding piece 5, and upper shell 1. Then, the lower shell 1 and upper shell 2 are connected and fixed, after the chamber is closed, the driving assembly 3 drives the rotating assembly 4 and upper grinding piece 5 to move, so that the grinding part 51 presses the material onto the lower grinding piece 6. Then, the rotating assembly 4 drives the grinding part 51 to rotate, and the material can be grinded. After grinding, the powdered material will fall down through the gaps between the coarse materials and be discharged into a space between the lower grinding piece 6 and the lower shell 2 through the through hole 61, allowing the grinding part 51 to always come into contact with the larger volume of material.

Compared to the grinding components that run through the entire grinding space, due to the disc-shaped structure of the grinding part 51, more space can be saved, allowing the grinding space to accommodate more materials.

In addition, due to the fact that the driving assembly 3 can drive the grinding part 51 to move, even if the coarse material continuously turns into a powder like material and the powder like material is continuously discharged from the grinding space through the through hole 61, the grinding part 51 can be moved by the driving assembly 3, reducing the grinding space and compacting the material in the grinding space, so that the grinding part 51 and the material can always maintain a large frictional force during relative motion, thus fully grinding the material. Overall, by using this electric grinder, more material can be accommodated and kept in a dense state throughout the grinding process, thus grinding the material more thoroughly.

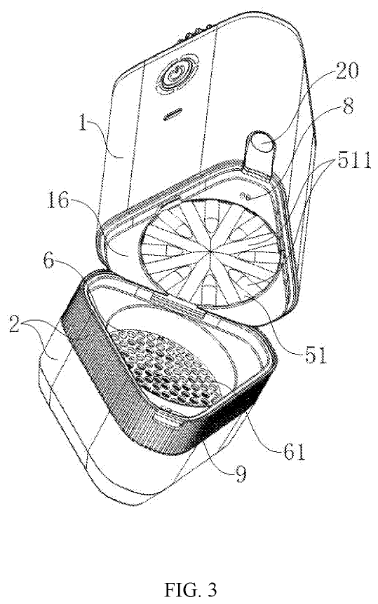

Referring to FIG. 3, it should be noted that the grinding part 51 of the above-mentioned disc-shaped structure is compared to those grinding teeth and grinding blades with a certain length, the disc-shaped structure has a certain thickness, but the thickness in the vertical direction is much smaller than the length in the horizontal direction.

A grinding surface 511 of the grinding part 51 is not a flat plane, and it can have multiple regular or irregular grooves, multiple protrusions or patterns, etc., which can be flexibly selected according to actual needs. In present embodiment, one of the structures is introduced. Specifically, the upper grinding piece 5 is cylindrical in thickness, and the grinding part 51 includes two sets of grooves. Each of the two sets of grooves includes 8 long strip shaped grooves arranged in a circle, and two sets of grooves are alternately arranged. In addition, due to the fact that the grinding part 51 will eventually contact the lower grinding piece 6 during movement, making the grinding space almost non-existent, such that the electric grinder can grind all materials without any dead corners.

Based on the above scheme, the grinding part 51 is similar to a stone grinding blade, without protruding sharp edges or grinding teeth, which is less prone to injury and safer. At the same time, the grooved grinding part 51 can leave more space for accommodating materials. In addition, the grinding part 51 has the advantage of being easy to clean due to its small thickness, for example, if a brush is used for cleaning, the brush can directly clean the top and bottom of the grinding part 51, and it will not be obstructed by grinding components such as grinding teeth when moving.

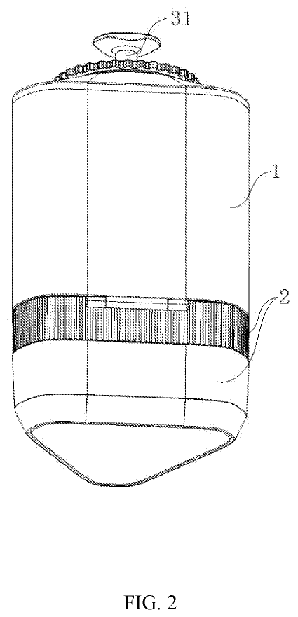

Referring to FIGS. 2 and 3, based on the above scheme, the following design is also carried out in this embodiment. Specifically, the lower shell 2 is rotatably connected to the upper shell 1, which can rotate around the upper shell 1 to open or to form the closed chamber. In addition, the lower shell 2 is detachably connected to the upper shell 1, with a portion of the lower shell 2 is still connected to the upper shell 1.

In conventional art, conventional grinding components are usually grinding teeth, grinding blade heads, etc. with a certain length, which causes the upper shell 1 and lower shell 2 to only move along the extension direction of the grinding components during disassembly and assembly. If they move in other directions, they will be interfered by the grinding components, therefore, the upper shell 1 and lower shell 2 will be completely separated after disassembly and need to be placed separately, making it inconvenient to take them out during installation; in addition, the upper shell 1 and lower shell 2 need to be aligned before installation, which is a cumbersome and time-consuming process. In present embodiment, due to the use of disc-shaped of the grinding part 51, similar to a planar structure, and the lower shell 2 being rotationally connected to the upper shell 1, the lower shell 2 can be rotated and opened, and during the opening process, it will not be interfered or obstructed by the grinding part 51. After opening, due to the presence of the rotating part, the lower shell 2 is still connected to the upper shell 1. When installing, only the lower shell 2 needs to be rotated, and there is no need to remove the lower shell 2 from other places or align and position it. The operation is simple, time-saving, and labor-saving; in addition, compared to the split structure, the flip type structure has stronger structural rigidity and is more secure after connection, making it difficult for the upper shell 1 and lower shell 2 to separate and fall off after connection.

Referring to FIGS. 1 and 3, further on the basis of the rotational connection between the lower shell 2 and the upper shell 1, the following design has been carried out in this embodiment. Specifically, the lower shell 2 and the upper shell 1 are detachably connected by pressing the buckle structure 20 when the chamber is closed. By pressing the buckle structure 20, the lower shell 2 and the upper shell 1 can be prevented from rotating each other, thereby fixing the relative position between the lower shell 2 and the upper shell 1. The overall structure is an insulated cup structure, simple structure, easy to operate when opening and closing.

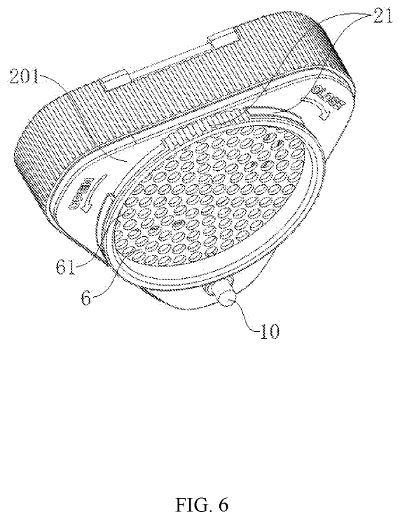

Referring to FIGS. 3-4 and 6, in order to determine whether the upper shell 1 and lower shell 2 are tightly connected, the following design has been carried out in this embodiment. Specifically, it also includes an energy supply device 7, a first conductive element 8, a second conductive element 9, and an alarm 10. The energy supply device 7 is installed on the upper shell 1; the first conductive element 8 is installed on the upper shell 1 and electrically connected to the energy supply device 7, and the second conductive element 9 is installed on the lower shell 2 and is corresponding to the first conductive element 8. After the chamber is closed, the first conductive element 8 and the second conductive element 9 can be in contact with each other. The alarm 10 is installed on the lower shell 2 and electrically connected to the second conductive element 9. After the chamber is closed, the energy supply device 7, the first conductive element 8, the second conductive element 9, and the alarm 10 can form a complete circuit to ensure the normal operation of the alarm 10, thereby reminding the user whether the chamber is closed.

Through the design of the above structure, when the upper shell 1 and lower shell 2 are not tightly connected, that is, when the chamber is not fully closed, the alarm 10 will not work properly, thus reminding the user that grinding operations cannot be carried out at this time and that it is necessary to reconnect the upper shell 1 and lower shell 2. Furthermore, in present embodiment, the following design has been carried out. Specifically, the energy supply device 7 uses batteries, the first conductive element 8 and the second conductive element 9 use two sets of contact type conductive elements, and the alarm 10 uses LED beads. After the upper shell 1 and lower shell 2 are tightly connected, the two sets of contact type conductive elements can be connected to each other to form a circuit, and the electricity provided by the battery makes the LED beads emit light, thereby reminding the user that at this time the chamber is in a closed state and grinding can be started or go on.

Furthermore, the lower shell 2 can be made of transparent material, and under the illumination of LED beads, it is easy to observe whether the grinding has been completed.

Referring to FIGS. 1, 6, and 11, since the material after grinding can be discharged from the grinding space through the through hole 61, the final powdered material will be collected in the lower part of the lower shell 2. The lower part of the lower shell 2 forms a storing space for storing the final powdered material. When taking it out, if the powdered material is directly poured, the pouring speed will be very slow due to the obstruction of the lower grinding piece 6. If the lower grinding piece 6 is removed first, it is necessary to remove the lower shell 2 and then remove the lower grinding piece 6 in two steps, such that in order to remove powdered materials, the operation is cumbersome and laborious, and the residue above the lower grinding piece 6 may also mix into the powdered materials, affecting the quality of the powdered materials. To solve the above problems, the following design is carried out in this embodiment. Specifically, the lower shell 2 includes the first shell 201 and the second shell 202, with the first shell 201 is hollow from a top to a bottom thereof, and the top detachably connected to the upper shell 1. The lower grinding piece 6 can be detachably connected inside the first shell 201. The second shell 202 has a top opening and can be detachably connected to the bottom of the first shell 201, and second shell 202 is used to collect or store the material after grinding in the grinding space.

Through the design of the above structure, the material after grinding in the grinding space will fall into the second shell 202. By removing the second shell 202, the powdered material after grinding can be directly taken out, and the operation is done in one step without being hindered by the lower grinding piece 6.

Furthermore, the first shell 201 and the second shell 202 can be detachably connected through magnetic suction or snap connections.

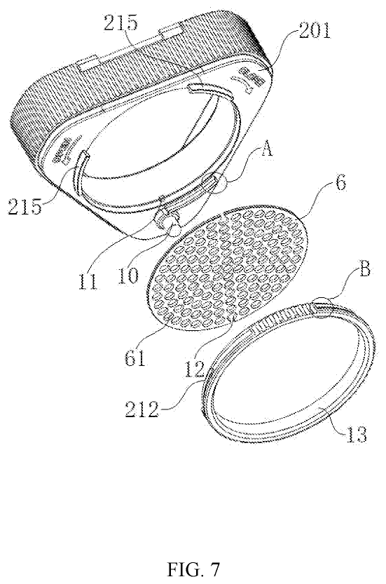

Referring to FIG. 7, there are various structures that can be detachably connected between the lower shell 2 and the lower grinding piece 6, and one of them is introduced in this embodiment. Specifically, on the basis of the lower shell 2 including the first shell 201 and the second shell 202, the outer surface of the lower grinding piece 6 is cylindrical. The electric grinder also includes a first limiting part 11, a second limiting part 12, and a connecting piece 13, and the first limiting part 11 is located on the first shell 201; the second limiting part 12 is located on the lower grinding piece 6 and corresponds to the first limiting part 11. The first limiting part 11 and the second limiting part 12 can cooperate with each other to prevent the first shell 201 and the lower grinding piece 6 from rotating each other. The connecting piece 13 is located below the first shell 201, there is a gap between the connecting piece 13 and the first shell 201, and the lower grinding piece 6 is located within the gap. The connecting piece 13 is in a circular shape to prevent blockage of the through hole 61. There is a rotatable buckle structure 21 between the connecting piece 13 and the first shell 201, so that the two can be locked and connected to each other by mutual rotation or unlocked and separated from each other, thereby installing or removing the lower grinding piece 6.

Furthermore, the first limiting part 11 uses a limiting block, the second limiting part 12 uses a limiting groove. The lower grinding piece 6 is assembled with the top thereof abutting against the first shell 201, the bottom thereof abutting against the connecting piece 13, and the side thereof abutting against the connecting piece 13, thus when rotating, the lower grinding piece 6 is hindered by the limiting block and the limiting groove, and is fixed between the first shell 201 and the connecting piece 13.

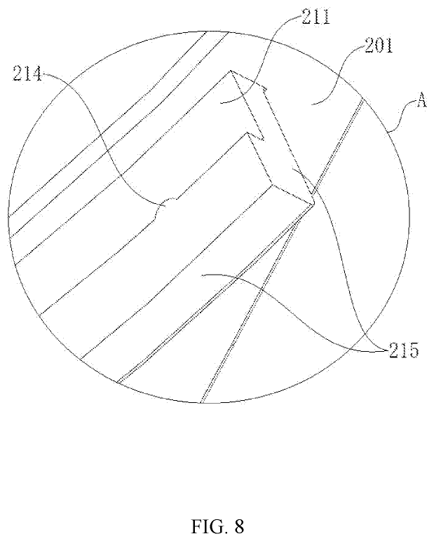

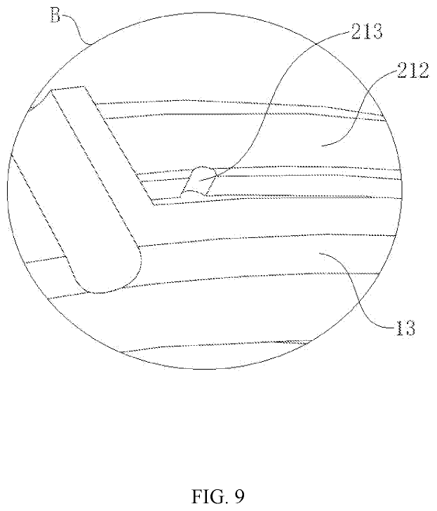

Referring to FIGS. 7-9, furthermore, the rotatable buckle structure 21 includes multiple convex bars 215, and multiple blocks 212. The multiple convex bars 215 are spaced arranged in a circle on one side of the first shell 201 away from the upper shell 1, and the inner walls of the convex bars 215 are slidably connected to the outer wall of the connecting piece 13. Each convex bar 215 is equipped with a groove 211 in the inner wall, and each groove 211 is arranged in an arc shape. The multiple grooves 211 on the convex bars 215 have the same center and radius. The multiple blocks 212 are located on the outer wall of connecting piece 13, with each block 212 corresponding to a groove 211. Each block 212 is arranged in an arc shape, and the length of the block 212 is smaller than the distance between adjacent grooves 211, so that the block 212 can move between adjacent grooves 211 and enter the groove 211 by rotation. Each block 212 is equipped with an insertion slot 213, and each groove 211 is equipped with an insertion protrusion 214 corresponding to the insertion slot 213, so that after the block 212 is rotated into the groove 211, the insertion protrusion 214 can enter the insertion slot 213, thereby fixing the relative position of the connecting piece 13 and the first shell 201.

In the present embodiment, the number of the convex bars 215 and the number of the blocks 212 each are three. The insertion slot 213 and the insertion protrusion 214 each are arc-shaped. Preferably, the convex bars 215, the blocks 212 and the insertion slot 213 can be elastic.

After the connection between the connecting piece 13 and the first shell 201 is completed, one side of the lower grinding piece 6 is pressed against the connecting piece 13, and the opposite side is pressed against the first shell 201, which can prevent the lower grinding piece 6 from moving in the direction perpendicular to the plane where the lower grinding piece 6 is located. The edge of the lower grinding piece 6 is prevented from rotating on the plane where the lower grinding piece 6 is located by the action of the first limiting part 11 and the second limiting part 12. Therefore, the lower grinding piece 6 can be completely fixed between the connecting piece 13 and the first shell 201.

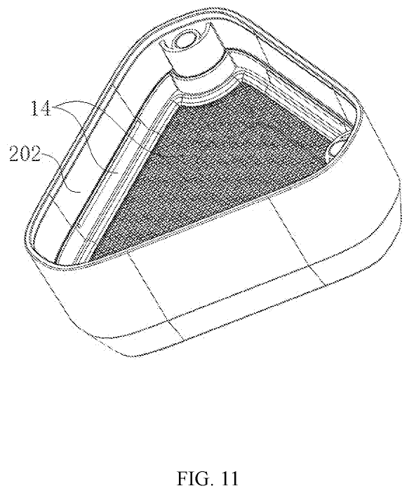

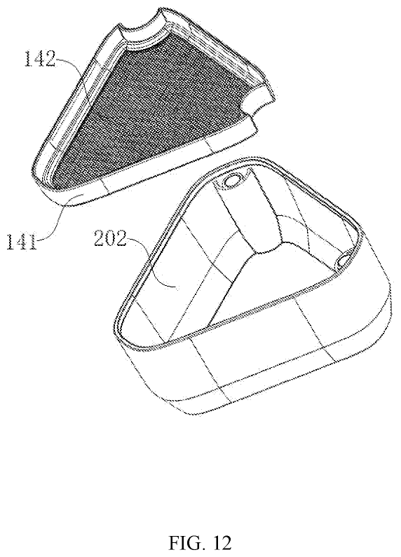

Referring to FIGS. 11 and 12, due to the fact that the driving assembly 3 drives the rotating assembly 4 and the upper grinding piece 5 to move during the grinding process, causing the grinding part 51 to compress the material, some materials that do not meet the size standards may be squeezed out of the grinding space through the through hole 61, thereby affecting the quality of the finished product after material grinding. To solve the above problems, the following design is carried out in this embodiment, specifically further including the filtering assembly 14, and the filtering assembly 14 includes a frame 141 and a filter screen 142. The frame 141 can be detachably connected to the second shell 202, and the filter screen 142 is installed in the frame 141 to filter the material after grinding in the grinding space.

Through the design of the above structure, the material passing through the through hole 61 will first fall onto the filter screen 142. As there is no external force at this time, materials that meet the size requirements will continue to fall through the filter screen 142 to the bottom of the second shell 202 for collection and store. Materials that do not meet the size requirements will remain on the filter screen 142. Then, the frame 141 will be taken out and the remaining material on the filter screen 142 will be poured into the grinding space again for grinding, until there is no more material residue on the filter screen 142, thus a powder like material with the required size can be obtained, and the particle size is more uniform.

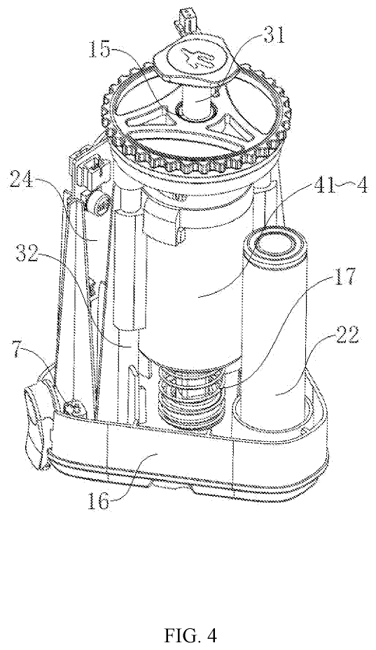

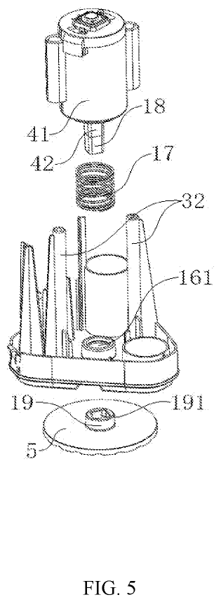

Referring to FIGS. 4 and 5, there are various structures that can drive the movement of the rotating assembly 4, and one of them is introduced in this embodiment. Specifically, the top of the upper shell 1 is provided with a guiding hole 15 that connects to the first chamber thereof, and the rotating assembly 4 includes a main body 41 that is non rotatable relative to the upper shell 1 and a driving shaft 42 that can rotate relative to the upper shell 1. The driving shaft 41 is connected to the upper grinding piece 5, and the driving assembly 3 includes a moving member 31 and a guiding member 32. The middle part of the moving member 31 is in a rod shape and is slidably connected to the guiding hole 15, with the two ends protrude to prevent the moving member 31 from detaching from the guiding hole 15. One end of the moving member 31 is connected to the main body 41 in the first chamber, and the moving member 31 extends along the direction of the first chamber. The guiding member 32 is fixed inside the upper shell 1 and extends along the direction of the first chamber, the main body 41 is slidable along the guiding member 32, so that the rotating assembly 4 can move in the direction of the guiding member 32 under the driving force of the moving member 31.

Through the design of the above structure, the rotating assembly 4 can be manually moved, allowing the operator to intuitively feel whether the material in the grinding space is compressed and in a dense state. Additionally, since the moving member 31 is connected to the main body 41, which slides along the guiding member 32, both the moving member 31 and the main body 41 will not be affected by the rotation of the driving shaft 42 during the movement process, enable the rotational force of driving shaft 42 to be converted into the energy source for grinding as much as possible.

Furthermore, the end of the moving member 31 located outside the chamber can be configured as a handle structure for gripping and applying force, while the end of the moving member 31 located inside the chamber can be configured as a buckle structure for inserting the middle part of the moving member 31 into the guiding hole 15.

Referring to FIGS. 3-5, this application does not specify the specific connection method between the moving member 31 and the main body 41, for example, it can be fixed or abutted. In the case of abutting, in order to prevent the moving member 31 and the main body 41 from moving back and forth, the following design is carried out in this embodiment. Specifically, it also includes a fixing member 16 and an elastic member 17. The fixing member 16 is installed inside the upper shell 1, and there is a hole 161 formed in the middle of the fixing member 16, the driving shaft 42 passes through the hole 161 and the protruding end is connected to the grinding piece 5. The upper and lower ends of the elastic member 17 are respectively connected to the main body 41 and the fixing member 16.

Through the design of the above structure, not only can the moving member 31 and the main body 41 always be in contact and under stress, thereby preventing the moving member 31, rotating assembly 4, and upper grinding piece 5 from moving back and forth, and allowing the moving member 31, rotating assembly 4, and upper grinding piece 5 automatically resetting after removing the influence of external forces; Furthermore, the elastic member 17 in this embodiment uses a spring, which is more convenient to operate.

Due to the fact that the upper grinding piece 5 always contacts and presses against the material during the grinding process, it is impossible for the upper grinding piece 5 to fall off in the direction of the material. In order to design an easy to disassemble upper grinding piece 5 based on this characteristic, the following design was carried out in this embodiment. Specifically, a first magnetic member 18 and a second magnetic member 19 are also included. The first magnetic member 18 is located at the exit end of the driving shaft 42, the second magnetic member 19 is located at the top of the upper grinding member 5, and there is a positioning hole 191 with an opening facing upwards formed at the top of the second magnetic component 19. The first magnetic member 18 can be inserted into the positioning hole 191 and magnetically connected to the second magnetic member 19, thereby fixing the relative position of the driving shaft 42 and the upper grinding piece 5.

Through the design of the above structure, the upper grinding piece 5 can be detached by exerting force in one direction during disassembly. However, due to the obstruction of the material in the detachment direction of the upper grinding piece 5 during the grinding process, it is impossible for the upper grinding piece 5 to detach. After the grinding is completed, the upper grinding piece 5 can be easily and quickly removed for cleaning, maintenance, replacement, and other operations. Due to the magnetic connection between the driving shaft 42 and the upper grinding piece 5, thus without the influence of external forces, it is also possible to prevent the upper grinding piece 5 from falling off the driving shaft 42. It should be noted that the cross-sections of the first magnetic member 18 and the positioning hole 191 are not circular to prevent relative rotation between the driving shaft 42 and the upper grinding piece 5. In this embodiment, the cross-sections of the first magnetic member 18 and the positioning hole 191 are preferably square with rounded corners.

Most existing herbal grinding equipment has fixed grinding accuracy, and for some herbal grinding equipment that only has grinding heads, they cannot even obtain uniformly thick and fine herbal powder. In order to solve the above problems, the following design has been carried out in this embodiment. Specifically, on the basis of the detachable connection of the lower grinding piece 6 to the lower shell 2, the lower grinding shell 6 has multiple types, and the aperture sizes of the through holes 61 on different types of lower grinding pieces 6 are different.

Through the design of the above structure, the thickness of material grinding can be adjusted by replacing different types of lower grinding pieces 6, which has a wider range of applications.

Referring to FIGS. 1 and 4, further, in order to form the electric grinder, the present application also includes the following design. Specifically, it also includes components such as battery 22, switch 23, control panel 24, and charging port 25. The Battery 22, switch 23, charging port 25, and the main body 41 are all electrically connected to control panel 24. The Battery 22 can be charged through the charging port 25, and the battery 22 can be powered by the switch 23, then, the rotating assembly 4 is controlled to work through the control panel 24. The structure in this scheme is based on existing technology and will not be elaborated here.

It should be noted that the terms used here are only for describing specific embodiments, and are not intended to limit exemplary embodiments according to this application. As used here, unless otherwise explicitly stated in the context, the singular form is also intended to include the plural form. In addition, it should be understood that when the terms including and/or including are used in this specification, they indicate the existence of features, steps, operations, devices, components, and/or their combinations.

In addition, it should be noted that the use of words such as first and second to define components is only for the purpose of distinguishing the corresponding components. Unless otherwise stated, the above words have no special meaning and cannot be understood as limiting the scope of protection of this application.

Although embodiments of the present invention have been shown and described, it can be understood by those skilled in the art that multiple variations, modifications, substitutions, and variations can be made to these embodiments without departing from the principles and spirit of the present invention. The scope of the present invention is limited by the accompanying claims and their equivalents.

What is claimed is:

1. An electric grinder for grinding materials, comprising:
an upper shell equipped with a first chamber having an opening at one end thereof;
a lower shell equipped with a second chamber having an opening at one end thereof, and the lower shell detachably connected to the upper shell to form a closed chamber enclosed by the first chamber and the second chamber;
a driving assembly installed on the upper shell and extending into the first chamber, and being movable along the first chamber;
a rotating assembly installed on the driving assembly, and a rotating plane of the rotating assembly intersecting with a movement direction of the driving assembly;
an upper grinding piece installed at an end of the rotating assembly near the lower shell, and an end of the upper grinding piece near the lower shell being equipped with a grinding part; and
a lower grinding piece detachably connected to the second chamber and enclosed with the lower shell, the upper grinding piece, and the upper shell to form a grinding space for grinding materials; the lower grinding piece being equipped with multiple through holes for discharging the material after grinding in the grinding space;
the driving assembly driving the rotating assembly to move, and the rotating assembly driving the upper grinding piece to rotate, so that the grinding part can move, squeeze, and rotate the material in the grinding space.

2. The electric grinder according to claim 1, wherein the lower shell is rotationally connected to the upper shell and can rotate around the upper shell to form the closed chamber to open the closed chamber, and when the closed chamber is opened, a portion of the lower shell is connected to the upper shell.

3. The electric grinder according to claim 1, wherein the lower shell comprises:
a first shell being hollow from a top thereof to a bottom thereof, with the top of the first shell detachably connected to the upper shell, and the lower grinding piece detachably connected inside the first shell; and
a second shell, a top of the second shell being opened and detachably connected to the bottom of the first shell, the second shell being configured to collect the material after grinding in the grinding space.

4. The electric grinder according to claim 3, wherein the outer surface of the grinding piece is cylindrical, and the electric grinder further comprises:
a first limiting part located on the first shell;
a second limiting part located on the lower grinding piece and corresponding to the first limiting part, the first limiting part and the second limiting part can cooperate with each other to prevent the first shell and the lower grinding piece from rotating each other; and
a connecting piece located below the first shell and a gap being maintained between the connecting piece and the first shell, the lower grinding piece located within the gap, and the connecting piece being in a circular shape, wherein there is a rotatable buckle structure arranged between the connecting piece and the first shell, so that the connecting piece and the first shell can be locked to be connected or unlocked to be separated by rotation, thereby installing or removing the lower grinding piece.

5. The electric grinder according to claim 4, wherein the rotatable buckle structure comprises:
multiple convex bars spaced arranged in a circle on one side of the first shell away from the upper shell, and inner walls of the convex bars slidably connected to an outer wall of the connecting piece, an inner wall of each of the convex bars being provided with a groove, and each of the grooves being arranged in an arc shape, centers and radii of the multiple grooves are the same, and each of the grooves being equipped with an insertion protrusion; and
multiple blocks being located on the outer wall of the connecting piece, with each of the blocks corresponding to one of the grooves, and each of the blocks being arranged in an arc shape, and a length of the blocks being less than a distance between adjacent two of the grooves, so that the blocks can move between adjacent two of the grooves and enter the grooves by rotation, each of the blocks has an insertion slot, and after the blocks are rotated into the grooves, the insertion protrusion can enter the insertion slot, thereby fixing the relative position of the connecting piece and the first shell.

6. The electric grinder according to claim 3, further comprising filtering assembly comprising:
a frame detachably connected inside the second shell; and
a filter screen installed on the frame for filtering the material after grinding in the grinding space, wherein the filter screen is spaced from the bottom of the second shell at a distance to allow the material passing through the filter screen to fall to the bottom of the second shell for collection.

7. The electric grinder according to claim 1, wherein a top of the upper shell is provided with a guiding hole for connecting the first chamber, and the rotating assembly includes a main body non rotatable relative to the upper shell, and a driving shaft rotatable relative to the upper shell, the driving shaft is connected to the upper grinding piece; and the driving assembly comprises:
a moving member, a middle part of the moving member being in a rod shape and slidably connected to the guiding hole, with both ends protruding to prevent the moving member from detaching from the guiding hole, one end of the moving member located in the first chamber is connected to the main body, and the moving member extends along the first chamber; and
a guiding member fixed inside the upper shell extending along the direction of the first chamber, and the main body being slidable along the guiding member, so that the rotating assembly can move along the guiding member under a driving force of the moving member.

8. The electric grinder according to claim 7, further comprising:
a fixing piece installed inside the upper shell, and having a hole, an end of the driving shaft passing through the hole to be connected to the upper grinding piece; and
an elastic member having an upper end and a lower end being respectively connected to the main body and the fixing piece, so that the moving member, the rotating assembly, and the upper grinding piece can automatically reset after removing an influence of external forces.

9. The electric grinder according to claim 8, further comprising:
a first magnetic member located at an end of the driving shaft; and
a second magnetic member located at a top of the upper grinding piece, the top of the second magnetic member being equipped with a positioning hole with upward opening, the first magnetic member capable of being inserted into the positioning hole and connected to the second magnetic member by magnetic suction, thereby fixing the relative position of the driving shaft and the upper grinding piece.

10. The electric grinder according to claim 1, wherein upper grinding piece has a disc-shaped structure, and diameters of the multiple through holes of the lower grinding piece are the same or different.
